(19) United States
(12) Patent Application Publication
(10) Pub. No.: US 2026/0237532 A1
(43) Pub. Date: Aug. 13, 2026

(54) CONTAINMENT VACUUM BREAKER

(71) Applicant: NuScale Power, LLC, Corvallis, OR (US)

(72) Inventor: Taylor Coddington, Philomath, OR (US)

(21) Appl. No.: 19/459,728

(22) Filed: Jan. 26, 2026

Related U.S. Application Data
(60) Provisional application No. 63/755,326, filed on Feb. 7, 2025.

(51) Int. Cl. G21C 13/02; G21C 9/004; G21C 13/10; G21C 15/12; G21C 15/18

(52) U.S. Cl. CPC G21C 13/022; G21C 9/004; G21C 13/10; G21C 15/12; G21C 15/18

(57) ABSTRACT

A containment isolation system that includes a containment vessel at least partially submerged in a pool of water. The depth of the containment vessel within the pool of water may vary, as required. A reactor pressure vessel disposed within the containment vessel with a space between the containment vessel and the reactor pressure vessel to maintain a separation between them. The containment isolation system may also include an emergency core cooling system couplable to the reactor pressure vessel.

### CROSS-REFERENCED TO RELATED APPLICATIONS

This application claims priority to U.S. Provisional Patent Application No. 63/55,326, filed Feb. 7, 2025, and titled “CONTAINMENT VACUUM BREAKER,” which is incorporated herein by reference in its entirety.

### STATEMENT REGARDING FEDERALLY SPONSORED RESEARCH

This invention was made with Government support under Contract No. DE-NE-0008928 awarded by the Department of Energy. The Government has certain rights in this invention.

### BACKGROUND

In order to minimize the potential for an accidental discharge of contaminated and/or irradiated particles, a containment vessel is positioned around the nuclear reactor. Penetrations through the containment vessel are limited in order to further minimize the potential for accidental discharge of contaminated and/or irradiated particles. In some circumstances, it may be desirable for the containment vessel to prevent fluid from exiting the containment area and also allow fluid to enter the containment area. In order to allow for the ability to restrict undesired fluid flow from a containment vessel and provide a means for allowing desirable fluid flow into the containment vessel, from the same containment vessel penetration, a new design is required.

### BRIEF DESCRIPTION OF THE DRAWINGS

FIG. 1 schematically illustrates a representation of a nuclear power plant that includes a nuclear power plant system including a Nuclear Power Module (NPM) implementing a Containment Vacuum Breaker, according to an embodiment of this disclosure.

FIG. 2 schematically illustrates a representation of a nuclear power plant system including an NPM implementing a Containment Vacuum Breaker, according to an embodiment of this disclosure.

FIG. 3 schematically illustrates a representation of a nuclear power plant system including an emergency core cooling system having a flow path within the NPM implementing the containment vacuum breaker, according to an embodiment of this disclosure.

FIG. 4 schematically illustrates a representation of a nuclear power plant system including a decay heat removal system having a fluid flow path and an emergency core cooling system having a flow path within the NPM implementing the containment vacuum breaker, according to an embodiment of this disclosure.

FIG. 5 is a partially schematic, partially cross-sectional view of a nuclear reactor system configured in accordance with embodiments of the present technology.

FIG. 6 is a partial schematic, partial cross-sectional view of a nuclear reactor system configured in accordance with additional embodiments of the present technology.

FIG. 7 is a schematic view of a nuclear power plant system including multiple nuclear reactors in accordance with embodiments of the present technology.

### DETAILED DESCRIPTION

### Overview

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

Some Small Modular Reactor (SMR) designs include a containment vessel (“CV”) partially submerged in a pool of water. While submerged in the pool of water, the CV may reach cold sub-atmospheric conditions following reactor trip (e.g., emergency shut down, normal shut down, etc.) and actuation of the emergency core cooling system (“ECCS”). The cold sub-atmospheric conditions may challenge the ability to keep the core covered and subcritical passively (i.e., without operator interaction), both of which are critical for ensuring core-coolability following a design basis event.

This disclosure is directed to an NPM that is partially submerged in a pool of water. In an embodiment, condensation may form on an inside surface of the CV and collect into a condensation pool. The condensation may pass into a reactor pressure vessel (“RPV”) within the CV via a recirculation valve that penetrates the RPV. The condensation may at least partially cover the core and provide a means to absorb heat (e.g., decay heat, etc.) from the core. The condensation may absorb the heat from the core and evaporate into a vapor. The vapor may rise and exit the RPV via a vent valve that penetrates the top end of the RPV. In an embodiment, the vapor may condense on the portion of the inside surface of the CV that is submerged in the pool of water.

In an embodiment, the vapor escaping the RPV via the vent valve may cause a small pressure difference (i.e., differential pressure) between the pressurizer (i.e., the upper area of the RPV) and the containment area (i.e., the area between the CV and the RPV), and the differential pressure between the pressurizer and the containment area may be offset by the hydrostatic head of the liquid condensate within the CV. If the pressure within the containment area increases independent of the pressure within the pressurizer, then the volume of vapor allowed to exit the RPV will decrease, which will cause an increase of pressure within the RPV.

Increased differential pressure across the pressure within the RPV vent valves may limit the amount of liquid condensate that may enter the RPV via the recirculation valve, which can reduce the volume of condensate within the RPV. Since heat is removed from the core via the liquid condensate, a decreased volume of liquid condensate within the core may cause at least a portion of the core to be uncovered due to the buildup of vapor, which may displace the water within the core.

In an embodiment, introducing non-condensable gases (e.g., nitrogen, atmospheric air, etc.) into the containment area may reduce the effectiveness of condensation heat transfer between the vapor and the inside surface of the CV, which may increase the overall pressure within the containment area. Because the pressure in the CV and RPV are linked during ECCS, increases in the CV pressure may result in increases in RPV pressure. Increased pressures may result in the gas density to increase. Under steady, or quasi-steady, conditions, the condensate mass flow rate entering the RPV via the recirculation valves is approximately constant and matches the vapor mass flow rate exiting the RPV via the vent valves. Accordingly, increased density of the RPV gases results in a reduced volumetric flow rate for a constant mass flow rate and may cause a reduced differential pressure between the pressurizer and the containment area across the vent valve.

As the differential pressure between the pressurizer and the containment area across the vent valve decreases, more vapor from within the RPV may flow into the containment area, thus decreasing the pressure in the RPV and allowing a greater volume of liquid condensate to flow into the RPV via the recirculation valve. The increased volume of the liquid condensate within the RPV may allow the core to remain covered with liquid and allow for the removal of heat from the core.

### Illustrative Embodiments

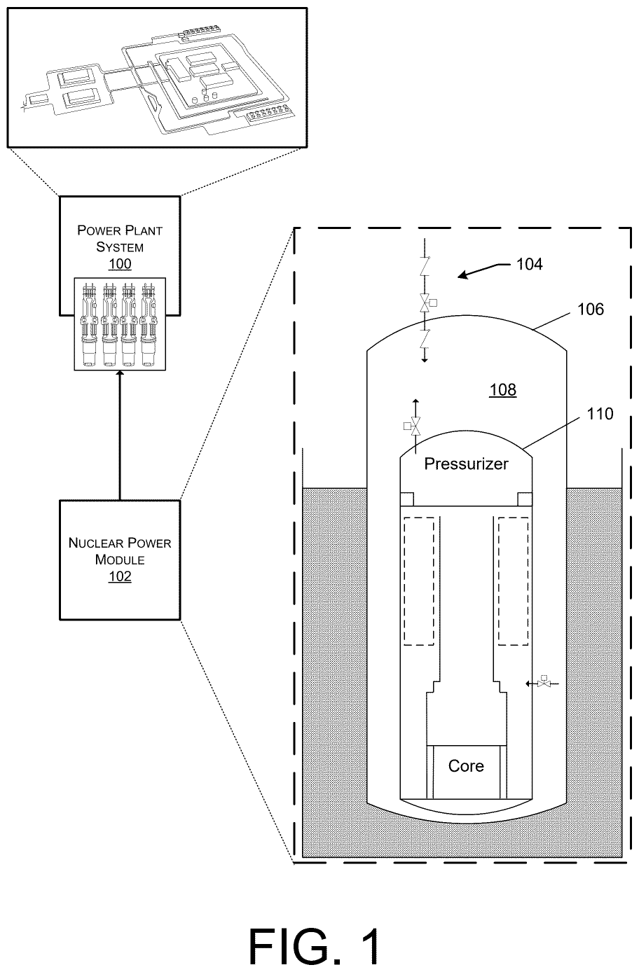

FIG. 1 schematically illustrates a representation of a Nuclear Power Plant System 100 (“system 100”) that includes a Nuclear Power Module (NPM) 102 implementing a containment vacuum breaker 104, according to an embodiment of this disclosure.

In the illustrated embodiment, the system 100 may include a multi-module power plant design with NPMs 102. In an embodiment, the system 100 may represent any type of power plant system, including any of various other types of nuclear reactors and/or nuclear reactor systems. For example, the system 100 may include multiple small modular reactors (SMRs) with the same or different sizes, or operating characteristics.

Within the system 100, the NPMs 102 may include the containment vacuum breaker 104. The vacuum breaker 104 may be configured to penetrate a CV 106 of the NPM 102 and provide a means to allow one or more gases into the containment area 108 between the CV 106 and a reactor pressure vessel (RPV) 110. In an embodiment, the one or more gases may include nitrogen, atmospheric air, or any other useful gas (e.g., non-condensable gases, etc.).

In an embodiment, the containment vacuum breaker 104 may include a series of valves (e.g., one or more check valves, one or more containment isolation valves, etc.). It is understood that the containment isolation valve may include multiple isolation valves within one housing (i.e., a first disc and seat assembly and a second disc and seat assembly within one housing) and/or multiple individual adjacent valves acting as a single containment isolation valve. In an embodiment, the containment vacuum breaker 104 may include one or more check valves installed upstream and/or one or more check valves installed downstream of the containment isolation valve.

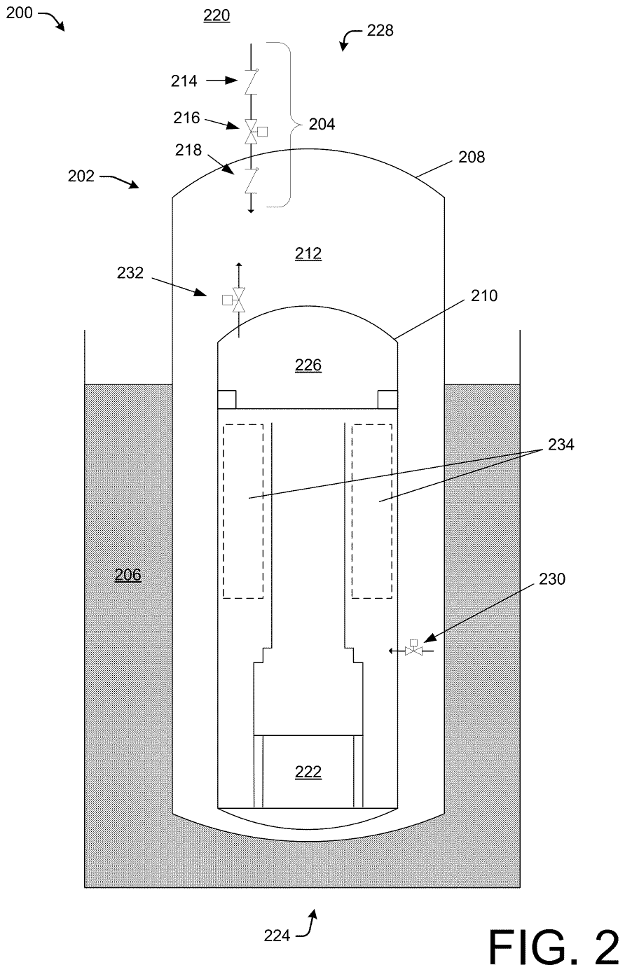

FIG. 2 schematically illustrates a representation of a Nuclear Power Plant System 200 (“system 200”) including an NPM 202 implementing a Containment Vacuum Breaker 204 (“vacuum breaker 204”). In an embodiment, the NPM 202 may be submerged in a water pool 206. In an embodiment, the NPM 202 may include the vacuum breaker 204, a CV 208, an RPV 210, and a containment area 212 (e.g., containment space, etc.) between the CV 208 and the RPV 210. In an embodiment the vacuum breaker 204 may include a first check valve 214 (e.g., upstream check valve, etc.), a containment isolation valve 216, and a second check valve 218. In an embodiment, the vacuum breaker 204 may penetrate the CV 208 and provide a flow path for air from the atmosphere 220 into the containment area 212.

In an embodiment, the containment isolation valve 216 may be closed during normal operation. For example, when power is available to the system 200, the containment isolation valve 216 may be closed. In an embodiment, the containment isolation valve 216 may be closed during abnormal conditions. For example, when power is not available to the system 200 (e.g., loss of power casualty, maintenance, etc.) the containment isolation valve may be closed. In an embodiment, the containment isolation valve 216 may be open by default (i.e., without operator action) and require operator action to be closed (e.g., normally open/fail shut).

In an embodiment, the RPV 210 may include a reactor core 222 at a bottom end 224 of the RPV 210 and a pressurizer 226 at a top end 228 of the RPV 210. In an embodiment, the RPV 210 may include a recirculation valve 230 (e.g., reactor recirculation valve, recirc valve, etc.), a vent valve 232 (e.g., reactor vent valve, etc.), and a steam generator 234. The recirculation valve 230 may penetrate the RPV 210 and may be configured to provide a liquid fluid flow path from the containment area 212 into the RPV 210. The reactor vent valve 232 may penetrate the RPV 210 and/or the pressurizer 226 and may provide a vapor flow path from inside the RPV 210 to the containment area 212.

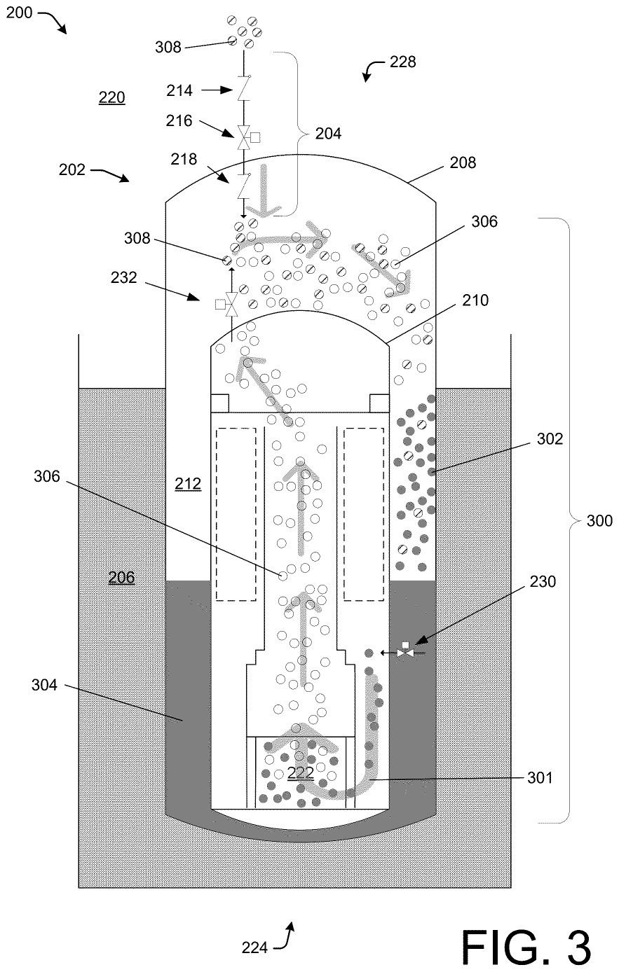

FIG. 3 schematically illustrates a representation of a nuclear power plant system 200 including an emergency core cooling system 300 having a flow path 301 (“flow path 301”) within the NPM 202 implementing the containment vacuum breaker 204 (“vacuum breaker 204”). In an embodiment, the emergency core cooling system 300 may be passive.

In an embodiment, condensation 302 may form on an inside surface of the CV 208 and collect into a condensation pool 304 formed within the containment area 212. The condensation 302 may pass through the recirculation valve 230 into the RPV 210. The condensation 302 may at least partially cover the core 222. The condensation 302 may absorb heat from the core 222 and evaporate into vapor 306. The vapor 306 may rise and exit the RPV 210 through the vent valve 232 and enter into the containment area 212.

In an embodiment, non-condensable gases 308 may travel from the atmosphere 220 through the vacuum breaker 204 into the CV 208. In an embodiment, the non-condensable gases 308 may travel from an external supply (e.g., gas tank, gas generation system, or other suitable source) through the vacuum breaker 204 into the CV 208. The non-condensable gases 308 may mix with the vapor 306 within the containment area 212, which may reduce condensation heat transfer effectiveness in the CV. In an embodiment, the potion of the CV 208 in contact with the water pool 206 may have a lower temperature relative to the portion of the CV 208 not submerged in the water pool 206. In an embodiment, the vapor 306 may condense on the inside surface of the CV 208 of the portion of the CV 208 that is submerged in the water pool 206 to form the condensation 302. The condensation 302 forming on the inside surface of the CV 208 may fall and collect into the condensation pool 304.

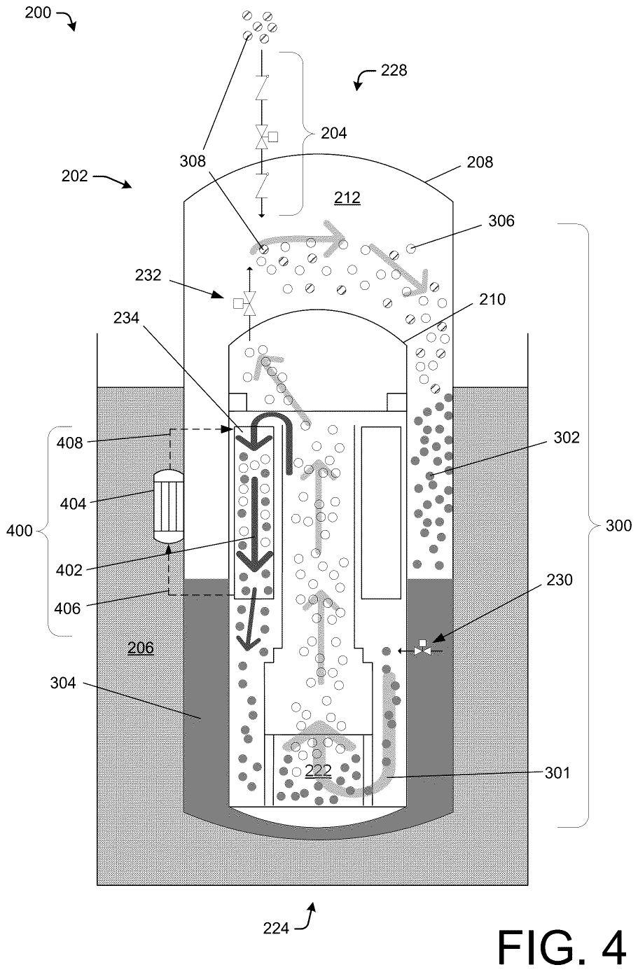

FIG. 4 schematically illustrates a representation of a nuclear power plant system 200 including a decay heat removal system 400 (“system 400”) having a fluid flow path 402 (“flow path 402”) and an emergency core cooling system 300 having a flow path 301 (“flow path 301”) within the NPM 202 implementing the containment vacuum breaker 204 (“vacuum breaker 204”). In an embodiment the system 400 may be passive.

In an embodiment, the system 400 may include the steam generator 234, a decay heat exchanger 404, a decay heat exchanger inlet 406, and a decay heat exchanger outlet 408. In an embodiment, the decay heat exchanger 404 may be coupled to an outside surface of the CV 208 and may be submerged within the water pool 206. In an embodiment, the decay heat exchanger inlet 406 may be coupled to a bottom end 224 of the steam generator 234 (e.g., lower end, first end, etc.). In an embodiment, the decay heat exchanger outlet 408 may be coupled to a top end 228 of the steam generator 234 (e.g., upper end, second end, etc.). In an embodiment, the system 400 may be filled with a fluid.

In an embodiment, the vapor 306 may pass downward through the steam generator 234. The vapor 306 may transfer heat into the steam generator 234 as it passes from the top end 228 of the steam generator 234 to the bottom end 224 of the steam generator 234. The vapor 306 may transfer enough heat to the steam generator 234 that the vapor 306 condenses into condensation 302 and fall back to the bottom end 224 of the RPV.

In an embodiment, the fluid within the top end 228 of the steam generator 234 may receive the heat from the vapor 306 and the heated fluid may flow through the steam generator 234 toward the bottom end 224 and into the decay heat exchanger 404 via the decay heat exchanger inlet 406. The decay heat exchanger 404 may transfer the heat from the heated fluid to the water pool 206 thereby cooling the fluid within the decay heat exchanger 404. The cooled fluid may flow from the decay heat exchanger 404 into the steam generator 234 via the decay heat exchanger outlet 408, where the cooled fluid will receive heat from the vapor 306.

In an embodiment, the addition of the non-condensable gases 308 into the containment area 212 may decrease the condensation heat transfer efficiency in CV 208, and result in higher system pressures. Increased system pressures may increase the heat removal fraction by system 400. The increased heat removal of the system 400 may cause a higher fraction of condensation 302 forming on the steam generator 234 within the RPV 210, which may reduce the vapor flow rate through vent valve 232 and associated differential pressure across the valve. The higher fraction of condensation 302 forming on the steam generator 234 within the RPV 210 reduces the volume of vapor within the RPV 210, which is also the ultimate result of the flow path 301 within the NPM 202 implementing the vacuum breaker 204.

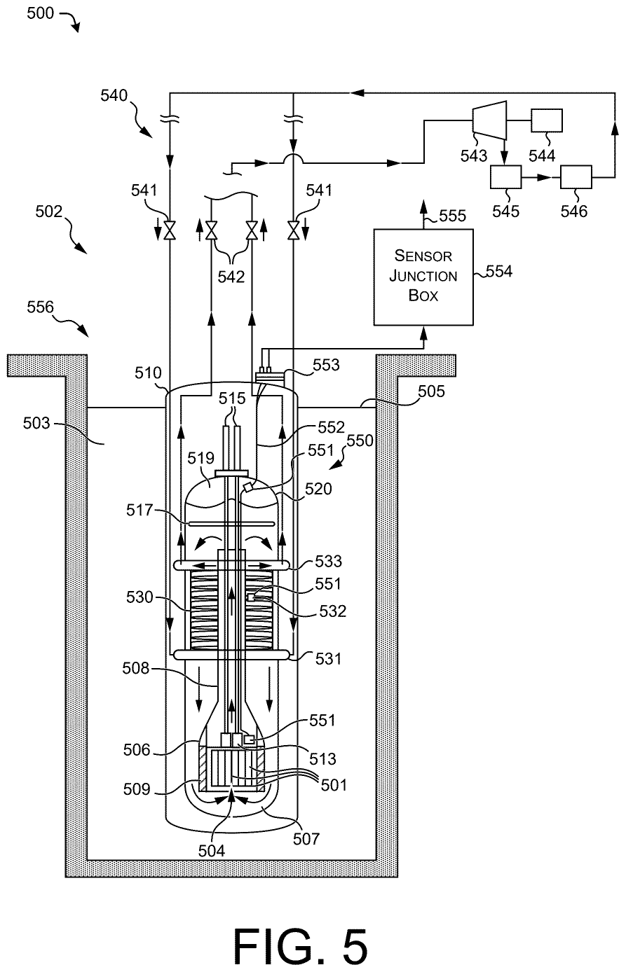

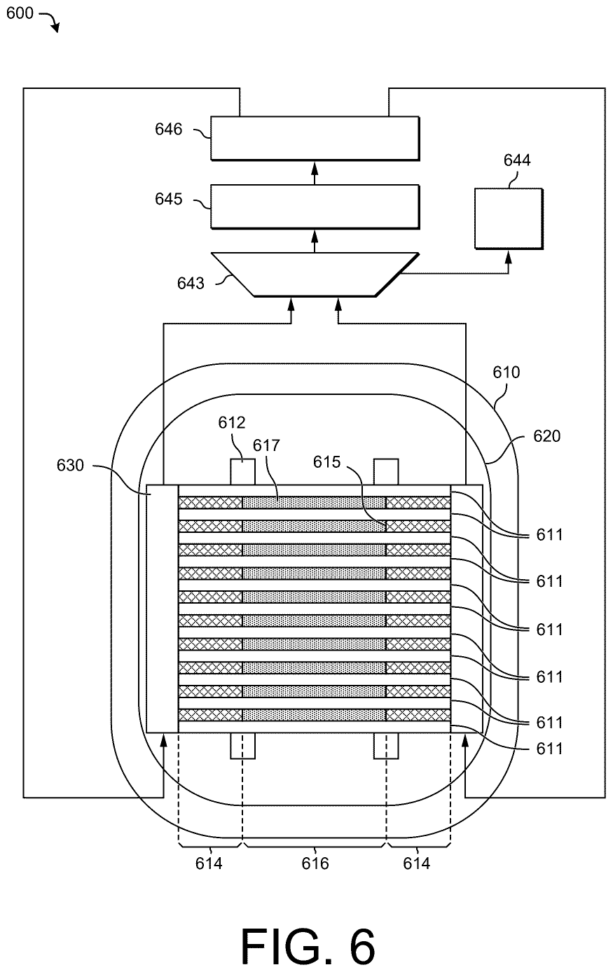

FIGS. 5 and 6 illustrate representative nuclear reactors that may be included in embodiments of the present technology. FIG. 5 is a partially schematic, partially cross-sectional view of a nuclear reactor system 500 configured in accordance with embodiments of the present technology. The system 500 can include a power module 502 having a reactor core 504 in which a controlled nuclear reaction takes place. Accordingly, the reactor core 504 can include one or more fuel assemblies 501. The fuel assemblies 501 can include fissile and/or other suitable materials. Heat from the reaction generates steam at a steam generator 530, which directs the steam to a power conversion system 540. The power conversion system 540 generates electrical power, and/or provides other useful outputs, such as super-heated steam. A sensor system 550 is used to monitor the operation of the power module 502 and/or other system components. The data obtained from the sensor system 550 can be used in real time to control the power module 502, and/or can be used to update the design of the power module 502 and/or other system components.

The power module 502 includes a containment vessel 510 (e.g., a radiation shield vessel, or a radiation shield container) that houses/encloses a reactor vessel 520 (e.g., a reactor pressure vessel, or a reactor pressure container), which in tum houses the reactor core 504. The containment vessel 510 can be housed in a power module bay 556. The power module bay 556 can contain a cooling pool 503 filled with water and/or another suitable cooling liquid. The bulk of the power module 502 can be positioned below a surface 505 of the cooling pool 503. Accordingly, the cooling pool 503 can operate as a thermal sink, for example, in the event of a system malfunction.

A volume between the reactor vessel 520 and the containment vessel 510 can be partially or completely evacuated to reduce heat transfer from the reactor vessel 520 to the surrounding environment (e.g., to the cooling pool 503). However, in other embodiments the volume between the reactor vessel 520 and the containment vessel 510 can be at least partially filled with a gas and/or a liquid that increases heat transfer between the reactor vessel 520 and the containment vessel 510. For example, the volume between the reactor vessel 520 and the containment vessel 510 can be at least partially filled (e.g., flooded with the primary coolant 507) during an emergency operation.

Within the reactor vessel 520, a primary coolant 507 conveys heat from the reactor core 504 to the steam generator 530. For example, as illustrated by arrows located within the reactor vessel 520, the primary coolant 507 is heated at the reactor core 504 toward the bottom of the reactor vessel 520. The heated primary coolant 507 (e.g., water with or without additives) rises from the reactor core 504 through a core shroud 506 and to a riser tube 508. The hot, buoyant primary coolant 507 continues to rise through the riser tube 508, then exits the riser tube 508 and passes downwardly through the steam generator 530. The steam generator 530 includes a multitude of conduits 532 that are arranged circumferentially around the riser tube 508, for example, in a helical pattern, as is shown schematically in FIG. 5. The descending primary coolant 507 transfers heat to a secondary coolant (e.g., water) within the conduits 532, and descends to the bottom of the reactor vessel 520 where the cycle begins again. The cycle can be driven by the changes in the buoyancy of the primary coolant 507, thus reducing or eliminating the need for pumps to move the primary coolant 507.

The steam generator 530 can include a feedwater header 531 at which the incoming secondary coolant enters the steam generator conduits 532. The secondary coolant rises through the conduits 532, converts to vapor (e.g., steam), and is collected at a steam header 533. The steam exits the steam header 533 and is directed to the power conversion system 540.

The power conversion system 540 can include one or more steam valves 542 that regulate the passage of high pressure, high temperature steam from the steam generator 530 to a steam turbine 543. The steam turbine 543 converts the thermal energy of the steam to electricity via a generator 544. The low-pressure steam exiting the turbine 543 is condensed at a condenser 545, and then directed (e.g., via a pump 546) to one or more feedwater valves 541. The feedwater valves 541 control the rate at which the feedwater re-enters the steam generator 530 via the feedwater header 531. In other embodiments, the steam from the steam generator 530 can be routed for direct use in an industrial process, such as a Hydrogen (H₂) and Oxygen (O₂) production plant, a chemical production plant, and/or the like, as described in detail below. Accordingly, steam exiting the steam generator 530 can bypass the power conversion system 540.

The power module 502 includes multiple control systems and associated sensors. For example, the power module 502 can include a hollow cylindrical reflector 509 that directs neutrons back into the reactor core 504 to further the nuclear reaction taking place therein. Control rods 513 are used to modulate the nuclear reaction and are driven via fuel rod drivers 515. The pressure within the reactor vessel 520 can be controlled via a pressurizer plate 517 (which can also serve to direct the primary coolant 507 downwardly through the steam generator 530) by controlling the pressure in a pressurizing volume 519 positioned above the pressurizer plate 517.

The sensor system 550 can include one or more sensors 551 positioned at a variety of locations within the power module 502 and/or elsewhere, for example, to identify operating parameter values and/or changes in parameter values. The data collected by the sensor system 550 can then be used to control the operation of the system 500, and/or to generate design changes for the system 500. For sensors positioned within the containment vessel 510, a sensor link 552 directs data from the sensors to a flange 553 (at which the sensor link 552 exits the containment vessel 510) and directs data to a sensor junction box 554. From there, the sensor data can be routed to one or more controllers and/or other data systems via a data bus 555.

FIG. 6 is a partially schematic, partially cross-sectional view of a nuclear reactor system 600 configured in accordance with additional embodiments of the present technology. In some embodiments, the nuclear reactor system 600 (“system 600”) can include some features that are at least generally similar in structure and function, or identical in structure and function, to the corresponding features of the system 500 described in detail above with reference to FIG. 5, and can operate in a generally similar or identical manner to the system 500.

In the illustrated embodiment, the system 600 includes a reactor vessel 620 and a containment vessel 610 surrounding/enclosing the reactor vessel 620. In some embodiments, the reactor vessel 620 and the containment vessel 610 can be roughly cylinder-shaped or capsule-shaped. The system 600 further includes a plurality of heat pipe layers 611 within the reactor vessel 620. In the illustrated embodiment, the heat pipe layers 611 are spaced apart from and stacked over one another. In some embodiments, the heat pipe layers 611 can be mounted/secured to a common frame 612, a portion of the reactor vessel 620 (e.g., a wall thereof), and/or other suitable structures within the reactor vessel 620. In other embodiments, the heat pipe layers 611 can be directly stacked on top of one another such that each of the heat pipe layers 611 supports and/or is supported by one or more of the other ones of the heat pipe layers 611.

In the illustrated embodiment, the system 600 further includes a shield or reflector region 614 at least partially surrounding a core region 616. The heat pipe layers 611 can be circular, rectilinear, polygonal, and/or can have other shapes, such that the core region 616 has a corresponding three-dimensional shape (e.g., cylindrical, spherical). In some embodiments, the core region 616 is separated from the reflector region 614 by a core barrier 615, such as a metal wall. The core region 616 can include one or more fuel sources, such as fissile material, for heating the heat pipe layers 611. The reflector region 614 can include one or more materials configured to contain/reflect products generated by burning the fuel in the core region 616 during operation of the system 600. For example, the reflector region 614 can include a liquid or solid material configured to reflect neutrons and/or other fission products radially inward toward the core region 616. In some embodiments, the reflector region 614 can entirely surround the core region 616. In other embodiments, the reflector region 614 may partially surround the core region 616. In some embodiments, the core region 616 can include a control material 617, such as a moderator and/or coolant. The control material 617 can at least partially surround the heat pipe layers 611 in the core region 616 and can transfer heat therebetween.

In the illustrated embodiment, the system 600 further includes at least one heat exchanger 630 (e.g., a steam generator) positioned around the heat pipe layers 611. The heat pipe layers 611 can extend from the core region 616 and at least partially into the reflector region 614 and are thermally coupled to the heat exchanger 630. In some embodiments, the heat exchanger 630 can be positioned outside of or partially within the reflector region 614. The heat pipe layers 611 provide a heat transfer path from the core region 616 to the heat exchanger 630. For example, the heat pipe layers 611 can each include an array of heat pipes that provide a heat transfer path from the core region 616 to the heat exchanger 630. When the system 600 operates, the fuel in the core region 616 can heat and vaporize a fluid within the heat pipes in the heat pipe layers 611, and the fluid can carry the heat to the heat exchanger 630. The heat pipes in the heat pipe layers 611 can then return the fluid toward the core region 616 via wicking, gravity, and/or other means to be heated and vaporized once again.

In some embodiments, the heat exchanger 630 can be similar to the steam generator 530 of FIG. 5 and, for example, can include one or more helically-coiled tubes that wrap around the heat pipe layers 611. The tubes of the heat exchanger 630 can include or carry a working fluid (e.g., a coolant such as water or another fluid) that carries the heat from the heat pipe layers 611 out of the reactor vessel 620 and the containment vessel 610 for use in generating electricity, steam, and/or the like. For example, in the illustrated embodiment the heat exchanger 630 is operably coupled to a turbine 643, a generator 644, a condenser 645, and a pump 646. As the working fluid within the heat exchanger 630 increases in temperature, the working fluid may begin to boil and vaporize. The vaporized working fluid (e.g., steam) may be used to drive the turbine 643 to convert the thermal potential energy of the working fluid into electrical energy via the generator 644. The condenser 645 can condense the working fluid after it passes through the turbine 643, and the pump 646 can direct the working fluid back to the heat exchanger 630 where it can begin another thermal cycle. In other embodiments, steam from the heat exchanger 630 can be routed for direct use in an industrial process, such as an enhanced oil recovery operation described in detail below. Accordingly, steam exiting the heat exchanger 630 can bypass the turbine 643, the generator 644, the condenser 645, the pump 646, etc.

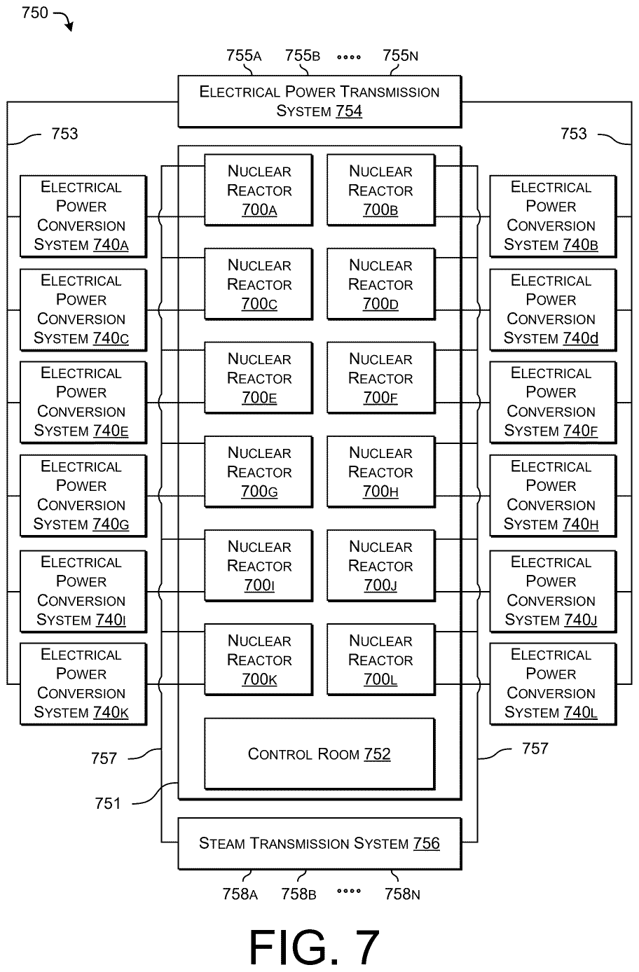

FIG. 7 is a schematic view of a nuclear power plant system 750 including multiple nuclear reactors 700 in accordance with embodiments of the present technology. Each of the nuclear reactors 700 (individually identified as first through twelfth nuclear reactors 700a-l, respectively) can be similar to or identical to the nuclear reactor 700 and/or the nuclear reactor 700 described in detail above with reference to FIGS. 5 and 6. The power plant system 750 (“power plant system 750”) can be “modular” in that each of the nuclear reactors 700 can be operated separately to provide an output, such as electricity or steam. The power plant system 750 can include fewer than twelve of the nuclear reactors 700 (e.g., two, three, four, five, six, seven, eight, nine, ten, or eleven of the nuclear reactors 700), or more than twelve of the nuclear reactors 700. The power plant system 750 can be a permanent installation or can be mobile (e.g., mounted on a truck, tractor, mobile platform, and/or the like). In the illustrated embodiment, each of the nuclear reactors 700 can be positioned within a common housing 751, such as a reactor plant building, and controlled and/or monitored via a control room 752.

Each of the nuclear reactors 700 can be coupled to a corresponding electrical power conversion system 740 (individually identified as first through twelfth electrical power conversion systems 740a-l, respectively). The electrical power conversion systems 740 can include one or more devices that generate electrical power or some other form of usable power from steam generated by the nuclear reactors 700. In some embodiments, multiple ones of the nuclear reactors 700 can be coupled to the same one of the electrical power conversion systems 740 and/or one or more of the nuclear reactors 700 can be coupled to multiple ones of the electrical power conversion systems 740 such that there is not a one-to-one correspondence between the nuclear reactors 700 and the electrical power conversion systems 740.

The electrical power conversion systems 740 can be further coupled to an electrical power transmission system 754 via, for example, an electrical power bus 753. The electrical power transmission system 754 and/or the electrical power bus 753 can include one or more transmission lines, transformers, and/or the like for regulating the current, voltage, and/or other characteristic(s) of the electricity generated by the electrical power conversion systems 740. The electrical power transmission system 454 can route electricity via a plurality of electrical output paths 755 (individually identified as electrical output paths 755a-n) to one or more end users and/or end uses, such as different electrical loads of an integrated energy system.

Each of the nuclear reactors 700 can further be coupled to a steam transmission system 756 via, for example, a steam bus 757. The steam bus 757 can route steam generated from the nuclear reactors 700 to the steam transmission system 756 which in tum can route the steam via a plurality of steam output paths 758 (individually identified as steam output paths 758a-n) to one or more end users and/or end uses, such as different steam inputs of an integrated energy system.

In some embodiments, the nuclear reactors 700 can be individually controlled (e.g., via the control room 752) to provide steam to the steam transmission system 756 and/or steam to the corresponding one of the electrical power conversion systems 740 to provide electricity to the electrical power transmission system 754. In some embodiments, the nuclear reactors 700 are configured to provide steam either to the steam bus 757 or to the corresponding one of the electrical power conversion systems 740 and can be rapidly and efficiently switched between providing steam to either. Accordingly, in some aspects of the present technology the nuclear reactors 700 can be modularly and flexibly controlled such that the power plant system 750 can provide differing levels/amounts of electricity via the electrical power transmission system 754 and/or steam via the steam transmission system 756. For example, where the power plant system 750 is used to provide electricity and steam to one or more industrial process-such as various components of the integrated energy systems, the nuclear reactors 700 can be controlled to meet the differing electricity and steam requirements of the industrial processes.

As one example, during a first operational state of an integrated energy system employing the power plant system 750, a first subset of the nuclear reactors 700 (e.g., the first through sixth nuclear reactors 700a-f) can be configured to provide steam to the steam transmission system 756 for use in the first operational state of the integrated energy system, while a second subset of the nuclear reactors 700 (e.g., the seventh through twelfth nuclear reactors 700g-l) can be configured to provide steam to the corresponding ones of the electrical power conversion systems 740 (e.g., the seventh through twelfth electrical power conversion systems 740g-l) to generate electricity for the first operational state of the integrated energy system. Then, during a second operational state of the integrated energy system when a different (e.g., greater or lesser) amount of steam and/or electricity is required, some or all the first subset of the nuclear reactors 700 can be switched to provide steam to the corresponding ones of the electrical power conversion systems 740 (e.g., the seventh through twelfth electrical power conversion systems 740g-l) and/or some or all of the second subset of the nuclear reactors 700 can be switched to provide steam to the steam transmission system 756 to vary the amount of steam and electricity produced to match the requirements/demands of the second operational state. Other variations of steam and electricity generation are possible based on the needs of the integrated energy system. That is, the nuclear reactors 700 can be dynamically/flexibly controlled during other operational states of an integrated energy system to meet the steam and electricity requirements of the operational state.

In contrast, some conventional nuclear power plant systems can typically generate either steam or electricity for output and cannot be modularly controlled to provide varying levels of steam and electricity for output. Moreover, it is typically difficult (e.g., expensive, time consuming, etc.) to switch between steam generation and electricity generation in conventional nuclear power plant systems. Specifically, for example, it is typically extremely time consuming to switch between steam generation and electricity generation in prototypical large nuclear power plant systems.

The nuclear reactors 700 can be individually controlled via one or more operators and/or via a computer system. Accordingly, many embodiments of the technology described herein may take the form of computer-or machine-or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured, or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

### CONCLUSION

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

As used herein, terms such as “attached,” “fastened,” “secured,” “disposed,” “connected,” and “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated and may include indirect connections through one or more intermediary elements. Likewise, the terms “directly” and “indirectly” describe both physical contact between components and connections made through intermediate structures, mechanisms, or devices.

What is claimed is:

1. A containment isolation system, comprising:
a containment vessel at least partially submerged in a water pool,
a reactor pressure vessel disposed within the containment vessel,
a space between the containment vessel and the reactor pressure vessel, and
an emergency core cooling system.

2. The containment isolation system according to claim 1, further comprising:
a heat exchanger submerged in the water pool, and
a steam generator disposed within the reactor pressure vessel, the steam generator fluidly coupled to the heat exchanger.

3. The containment isolation system according to claim 1, the emergency core cooling system including:
a vacuum breaker penetrating the containment vessel,
a vent valve penetrating an upper end of the reactor pressure vessel, and
a recirculation valve penetrating a lower end of the reactor pressure vessel.

4. The containment isolation system according to claim 3, wherein the vacuum breaker includes:
a first check valve disposed outside the containment vessel,
a second check valve disposed inside the containment vessel, and
a containment isolation valve disposed between the first check valve and the second check valve,
wherein the first check valve is fluidly connected to a first side of the containment isolation valve, and
the second check valve is fluidly connected to a second side of the containment isolation valve are fluidly connected.

5. The containment isolation system according to claim 3, wherein:
the vacuum breaker is closed during normal operation, and
the vacuum breaker is open on a loss of power.

6. The containment isolation system according to claim 3, wherein the vacuum breaker includes:
a first end fluidly connected to a non-condensable gas source, and
a second end fluidly connected to the space between the containment vessel and the reactor pressure vessel.

7. The containment isolation system according to claim 6, wherein the non-condensable gas source is atmospheric air.

8. The containment isolation system according to claim 6, wherein the non-condensable gas source is a tank.

9. A reactor core cooling system, comprising:
a containment vessel at least partially submerged in a water pool,
a reactor pressure vessel disposed within the containment vessel,
a space between the containment vessel and the reactor pressure vessel,
a vacuum breaker penetrating the containment vessel,
a vent valve penetrating an upper end of the reactor pressure vessel, and
a recirculation valve penetrating a lower end of the reactor pressure vessel.

10. The reactor core cooling system according to claim 9, further comprising a decay heat removal system.

11. The reactor core cooling system according to claim 10, the decay heat removal system including:
a heat exchanger submerged in the water pool, and
a steam generator disposed within the reactor pressure vessel, the steam generator fluidly coupled to the heat exchanger.

12. The reactor core cooling system according to claim 9, wherein the vacuum breaker includes:
a first check valve disposed outside the containment vessel,
a second check valve disposed inside the containment vessel, and
a containment isolation valve disposed between the first check valve and the second check valve.

13. The reactor core cooling system according to claim 12, wherein:
the first check valve is fluidly connected to a first side of the containment isolation valve, and
the second check valve is fluidly connected to a second side of the containment isolation valve are fluidly connected.

14. The reactor core cooling system according to claim 9, wherein the vacuum breaker includes:
a first end fluidly connected to a non-condensable gas source, and
a second end fluidly connected to the space between the containment vessel and the reactor pressure vessel.

15. The reactor core cooling system according to claim 14, wherein the non-condensable gas source is atmospheric air.

16. A nuclear power plant system, comprising:
a containment vessel at least partially submerged in a water pool,
a reactor pressure vessel disposed within the containment vessel,
a space between the containment vessel and the reactor pressure vessel,
an emergency core cooling system, and
a decay heat removal system.

17. The nuclear power plant system according to claim 16, the decay heat removal system including:
a heat exchanger submerged in the water pool, and
a steam generator disposed within the reactor pressure vessel, the steam generator fluidly coupled to the heat exchanger.

18. The nuclear power plant system according to claim 16, the emergency core cooling system including:
a vacuum breaker penetrating the containment vessel,
a vent valve penetrating an upper end of the reactor pressure vessel, and
a recirculation valve penetrating a lower end of the reactor pressure vessel.

19. The nuclear power plant system according to claim 18, the vacuum breaker including:
a first check valve disposed outside the containment vessel,
a second check valve disposed inside the containment vessel, and
a containment isolation valve disposed between the first check valve and the second check valve,
wherein the first check valve is fluidly connected to a first side of the containment isolation valve, and
the second check valve is fluidly connected to a second side of the containment isolation valve are fluidly connected.

20. The nuclear power plant system according to claim 19, wherein the vacuum breaker includes:
a first end fluidly connected to a non-condensable gas source, and
a second end fluidly connected to the space between the containment vessel and the reactor pressure vessel.
